(19) United States
(12) Patent Application Publication
(10) Pub. No.: US 2021/0358017 A1
(43) Pub. Date: Nov. 18, 2021

(54) Systems and Methods for Electronic Payment and Order Processing for Drop Shipment Systems

(71) Applicant: Inve-Share, LLC, Miami, FL (US)

(72) Inventor: Jonathan Barbara, Miami, FL (US)

(73) Assignee: Inve-Share, LLC, Miami, FL (US)

(21) Appl. No.: 17/318,952

(22) Filed: May 12, 2021

Related U.S. Application Data
(60) Provisional application No. 63/023,411, filed on May 12, 2020.

(51) Int. Cl. G06Q 30/06; G06Q 20/10; G06Q 10/08

(52) U.S. Cl. CPC G06Q 30/0635; G06Q 10/083; G06Q 20/102

(57) ABSTRACT

Systems and methods for electronic payment and order processing for a drop shipment system. The system generates a link to associate a product with a supplier and the system. The system receives an order confirmation from a distributor for the linked product where the linked product is offered for sale on a web site of the distributor. The system transmits a drop ship order fulfillment request to the supplier for the linked product and determines a revenue share payment associated with the linked product for each of the distributor and the supplier based on a revenue share payment agreement between the distributor and the supplier.

### RELATED APPLICATIONS

The present application claims the priority of U.S. Provisional Application Ser. No. 63/023,411 filed on May 12, 2020, the entire disclosure of which is expressly incorporated by reference.

### BACKGROUND

### Technical Field

The present disclosure relates generally to the field of electronic commerce. More particularly, the present disclosure relates to systems and methods for electronic payment and order processing for drop shipment systems.

### Related Art

The field of electronic commerce has become increasingly important for the purchase and receipt of consumer goods including, but not limited to, groceries, clothing, household products, toys and games, office supplies, furniture, home fitness equipment, etc. However, suppliers and distributors that utilize electronic commerce platforms to move these consumer goods often suffer from supply chain bottlenecks and challenges. For example, suppliers can suffer from an abundance of inventory due to cancelled retail orders, eroded margins from unsold goods and impacted revenue turnover, excessive costs of customer acquisition, limited consumer good exposure and consumers beyond proprietary mailing lists and social followings, limited cash flow, declining top line sales and sales forecasts, and business risk on receivables. Similarly, distributors can suffer from obligations to accept inventory from placed orders, eroded margins from unsold goods and impacted revenue turnover, a need for new consumer goods and/or seasonal goods, limited cash flow, declining top line sales and sales forecasts, and limited access to financed capital.

As such, there is a need to solve for the complexities encountered by suppliers and distributors with respect to electronic commerce supply chain bottlenecks and challenges. For example, it would be desirable for suppliers to realize higher margin sales due to diminishing wholesale and retail markets, expose inventory to larger consumer pools, improve cash flow and minimize business risk on receivables. It would also be desirable for distributors to expose an increased volume of goods and a number of brands with limited inventory risk, realize higher margin sales due to diminishing wholesale and retail markets, expose inventory with limited liability, access financing capital, and increase traffic based on a steady flow of new goods.

Thus, in view of the existing technology in this field, what would be desirable is a system that automatically, seamlessly, and efficiently provides for electronic payment and order processing for drop shipment systems. Accordingly, the systems and methods disclosed herein solve these and other needs.

### SUMMARY

The present disclosure relates to a system and method for electronic payment and order processing for drop shipment systems. In particular, the system generates a link to associate a product with a supplier and the system. The system receives an order confirmation from a distributor for the linked product where the linked product is offered for sale on a website of the distributor. The system transmits a drop ship order fulfillment request to the supplier for the linked product and determines a revenue share payment associated with the linked product for each of the distributor and the supplier based on a revenue share payment agreement between the distributor and the supplier. The system can prompt a payment processor to distribute the determined revenue share payment associated with the linked product to the distributor and can update an inventory of the linked product. Additionally, the system can determine a transaction fee for determining the revenue share payment and prompt the payment processor to deduct the determined transaction fee from the determined revenue share payment associated with the linked product for the supplier and to distribute the modified revenue share payment associated with the linked product to the supplier.

In another embodiment, the system generates a backend marketplace to list a product with a supplier using the supplier's current systems and software, without requiring the use of an additional software. The system allows distributors to shop for products from a supplier and seamlessly add them to their websites at the click of a button. Then, the distributors list the items on their website as they would any product. The system then receives orders from customers, at which point an order for a non-inventoried item made by a customer of the distributor will automatically be transmitted (with no additional clicks or other user actions required) into the existing system of the suppliers. At the time a customer checks out on the distributor's site, the system activates a payment processor that recognizes that there is a non-inventoried item. Once the payment processor is activated, a normal transaction for the customer of the distributor is continued, and the processor processes payment for the entirety of the order on behalf of the distributor. In capturing payment for the entire order, the system can attribute and split the payments (e.g., in accordance with pre-negotiated business terms between supplier and distributor) so that portions are paid to the supplier and distributor automatically (e.g., from a credit card or electronic transaction). The system can prompt a payment processor to distribute the determined revenue share payment associated with the linked product to the distributor and can update an inventory of the linked product. Additionally, the system can determine a transaction fee for determining the revenue share payment and prompt the payment processor to deduct the determined transaction fee from the determined revenue share payment associated with the linked product for the supplier and to distribute the modified revenue share payment associated with the linked product to the supplier. The supplier can then fulfill the order on behalf of the distributor, and in doing so, close out the order in their system and mark it as fulfilled, causing the system to automatically update the distributor with all relevant information for the fulfillment.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart illustrating conventional electronic payment and order processing for a drop shipment system;

FIG. 2 is a diagram illustrating an embodiment of the system of the present disclosure;

FIG. 3 is a flowchart illustrating overall process steps carried out by the system of the present disclosure;

FIG. 4 is a flowchart illustrating an integration of the system of the present disclosure within an electronic commerce system;

FIG. 5 is a flowchart illustrating drop shipment module processing carried out by the system of the present disclosure;

FIG. 6 is a flowchart illustrating transaction processing carried out by the system of the present disclosure;

FIG. 7 is a flowchart illustrating customer order flow carried out by the system of the present disclosure;

FIG. 8 is a flowchart illustrating order processing carried out by the system of the present disclosure;

FIG. 9 is a flowchart illustrating payment processing carried out by the system of the present disclosure;

FIG. 10 is a diagram illustrating an embodiment of the system of the present disclosure;

FIGS. 11-13 are flowcharts illustrating another embodiment of the present disclosure;

FIG. 14 is diagram illustrating hardware and software components of the embodiment of FIGS. 11-13 of the present disclosure; and

FIGS. 15-16C depicts screenshots showing user interface screens generated by the system of the present disclosure.

### DETAILED DESCRIPTION

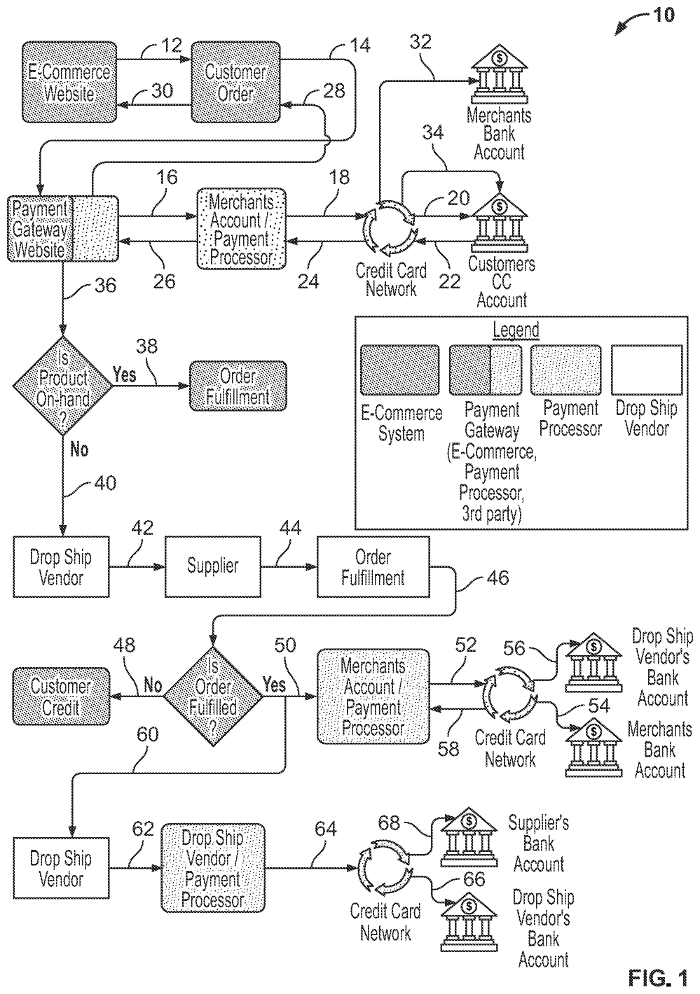

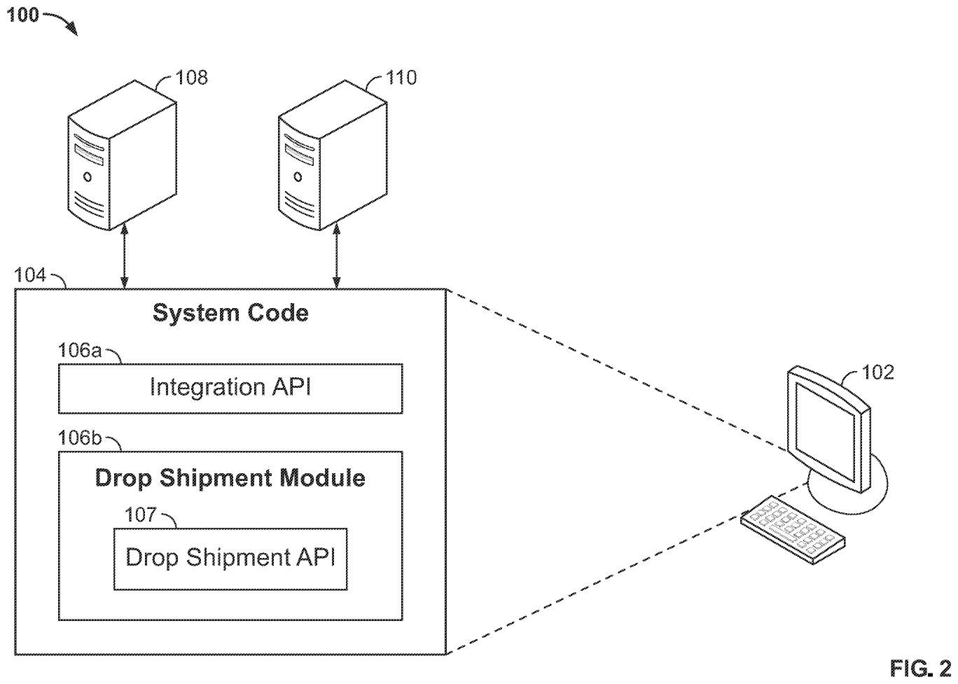

The present disclosure relates to systems and methods for electronic payment and order processing for drop shipment systems, as described in detail below in connection with FIGS. 1-16C.

FIG. 1 is a flowchart 10 illustrating conventional electronic payment and order processing for a drop shipment system. It should be understood that steps 12, 14, 38, 48 and 50 are carried out by an electronic commerce (e-commerce) system, steps 18, 26, 52, and 64 are carried out by a payment processor, steps 16, 28 and 36 are carried out by a payment gateway, and steps 42, 44, 46, and 62 are carried out by a drop ship vendor.

Beginning in step 12, a customer places on order on an e-commerce website of the e-commerce system. Then, in step 14, a payment gateway processes the customer order. It should be understood that the payment gateway can be a third party e-commerce payment processor (e.g., Paypal). In step 16, the payment gateway routes the customer order to a payment processor of a merchant associated with the customer order. In step 18, the merchant payment processor processes payment for the customer order via a credit card network. In particular, in step 20, the credit card network charges the customer's credit card account for the customer order, and in step 22, the bank associated with the customer's credit card account authorizes the charge for the customer order. Next, in step 24, the credit card network forwards the bank authorization to the merchant payment processor, and in step 26, the merchant payment processor forwards the bank authorization to the payment gateway. In steps 28 and 30, the payment gateway forwards the bank authorization for the customer order placed on the e-commerce web site of the e-commerce system. In step 32, upon receipt of the bank authorization by the e-commerce website, payment for the customer order is deposited into a bank account of the merchant associated with the customer order. Additionally in step 34, upon receipt of the bank authorization by the e-commerce website, the e-commerce website collects payment for the customer order from the bank associated with the customer's credit card account.

In step 36, the e-commerce system determines whether the product associated with the customer order is on hand. If the product is on hand, then in step 38 the e-commerce system fulfills the customer order. Alternatively, if the product is not on hand, then in step 40 the e-commerce system forwards the customer order to a drop ship vendor. In step 42, the drop ship vendor procures the product from a supplier, and in step 44, the drop ship vendor fulfills the customer order. In step 46, the e-commerce system determines whether the customer order is fulfilled. If the e-commerce system determines that the customer order is not fulfilled, then in step 48 the e-commerce system issues the customer a credit for the customer order. Alternatively, if the e-commerce system determines that the customer order is fulfilled, then in step 50 the e-commerce system routes the customer order to the payment processor of the merchant associated with the customer order.

In step 52, the merchant payment processor processes payment for the customer order via the credit card network. In steps 54 and 56, the credit card network respectively deposits payment (e.g., a transaction fee) for fulfilling the customer order in each of the bank account of the merchant and the bank account of the drop ship vendor. In step 58, the credit card network forwards payment confirmation of the merchant and drop ship vendor to the merchant payment processor. Then, in step 60, the merchant processor forwards the payment confirmation to the drop ship vendor. In step 62, upon receipt of the payment confirmation by the drop ship vendor, the drop ship vendor forwards the customer order to a payment processor of the drop ship vendor. In step 64, the drop ship payment processor processes payment for the customer order via the credit card network. In steps 66 and 68, the credit card network respectively deposits payment (e.g., a transaction fee) for fulfilling the customer order in each of the bank account of the drop ship vendor and the bank account of the supplier.

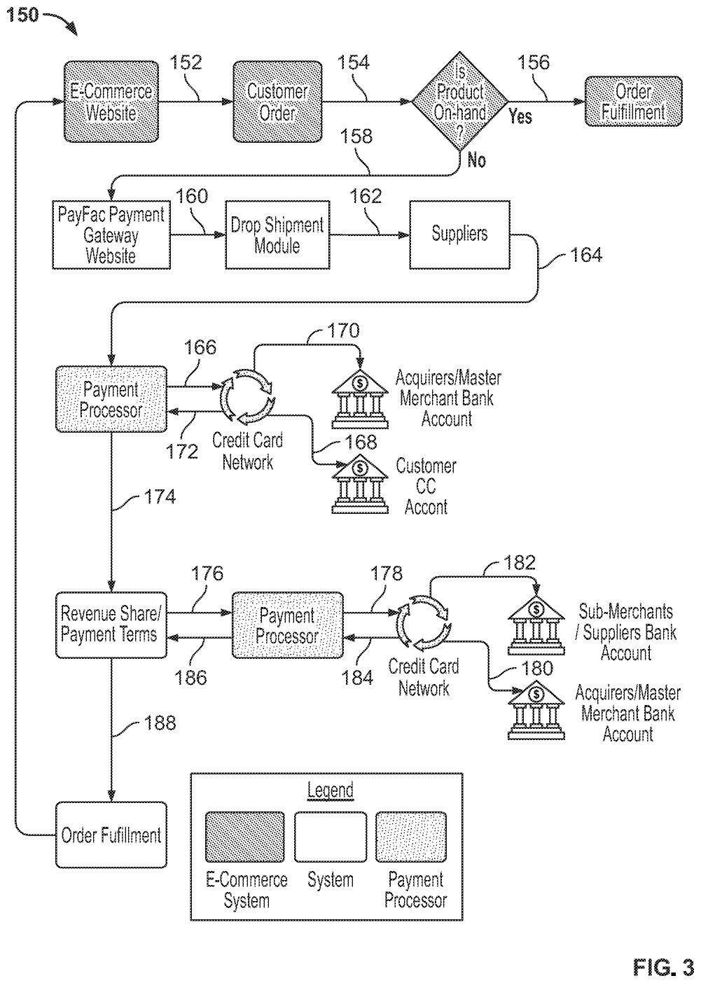

FIG. 2 is a diagram illustrating an embodiment of the system 100 of the present disclosure. The system 100 could be embodied as a central processing unit (e.g. a hardware processor) of a computer system 102 coupled to a supplier server 108 and a distributor server 110. The hardware processor can execute system code 104 (i.e., non-transitory computer-readable instructions) that is configured to execute electronic payment and order processing for a drop shipment system. The hardware processor could include, but is not limited to, a personal computer, a laptop computer, a tablet computer, a smart telephone, a server, and/or a cloud-based computing platform.

The system code 104 could include various custom-written software modules that carry out the steps/processes discussed herein, and could include, but is not limited to, an integration application programming interface (API) 106a and a drop shipment module 106b including a drop shipment API 107. The system code 104 could be programmed using any suitable programming languages including, but not limited to, C, C++, C#, Java, Python or any other suitable language. Additionally, the system code 104 could be distributed across multiple computer systems in communication with each other over a communications network, and/or stored and executed on a cloud computing platform and remotely accessed by a computer system in communication with the cloud platform. The system code 104 could communicate with the supplier server 108 and the distributor server 110 via the integration API 106a, which could be stored on the same computer system as the system code 104, or on one or more other computer systems in communication with the system code 104.

Still further, the system 10 could be embodied as a customized hardware component such as a field-programmable gate array (“FPGA”), application-specific integrated circuit (“ASIC”), embedded system, or other customized hardware component without departing from the spirit or scope of the present disclosure. It should be understood that FIG. 2 is only one potential configuration, and the system 100 of the present disclosure can be implemented using a number of different configurations.

The system 100 bridges a gap between a distributor and a supplier as an automated solution for drop shipping an e-commerce customer order and distributing a revenue share payment associated with the customer order for each of the distributor and supplier. The system 100 integrates with a distributor payment processor via the integration API 106a and can capture a payment at a moment that a customer provides payment on a website of a distributor. While the customer views a single transaction at checkout, the system 100 provides payments to all parties associated with the drop shipment.

The drop shipment module 106b does not require additional order processing or invoice management for a distributor and the drop shipment API 107 allows each of a distributor and a supplier to integrate with the drop shipment module 106b. As such, the system 100 provides for a steady flow of new inventory for a distributor while minimizing risk and also provides for higher margins for each of the distributor and supplier. Additionally, the distributor can realize a sales commission on each customer order while protecting personal identification information of that customer and without incurring a cost for fulfilling the customer order.

The supplier can integrate with the system 100 via the integration API 106a and expose products across a greater spectrum of retailers and customers than the supplier would generally have access to via proprietary direct to consumer channels. The supplier can also improve cash flow at a higher margin via the revenue share payment in comparison to the conventional system of FIG. 1. The system 100 also provides a distributor and supplier a platform to negotiate specific terms of their revenue share. It should be understood that a distributor can elect to delay the revenue share payment to a supplier in which case the system 100 can capture a payment at a moment that a customer provides payment, serve as a financing vehicle for the distributor, and provide the revenue share payment to the supplier on a later specified date. It should also be understood that a distributor can integrate with the system 100 without incurring a cost while a supplier can incur a monthly or yearly subscription fee for integrating with the system 100 based on sales volume in addition to a transaction fee for each customer order processed by the system 100.

FIG. 3 is a flowchart 150 illustrating overall process steps carried out by the system 100 of the present disclosure. It should be understood that steps 152, 154, and 156 are carried out by an e-commerce system, steps 160, 162, 164, 176, and 188 are carried out by the system 100, and steps 166, 174, 178, and 186 are carried out by a payment processor.

Beginning in step 152, a customer places on order on an e-commerce website of the e-commerce system. Then, in step 154, the e-commerce system determines whether the product associated with the customer order is on hand. If the product is on hand, then in step 156 the e-commerce system fulfills the customer order. Alternatively, if the product is not on hand, then in step 158 the e-commerce system forwards the customer order to a payment gateway of the system 100.

In step 160, the payment gateway routes the customer order to a drop shipment module of the system 100. In step 162, the drop shipment module generates and transmits a drop shipment request to procure the product from a supplier. Then, in step 164, the system 100 routes the customer order to a payment processor. In step 166, the payment processor processes payment for the customer order via a credit card network. In steps 168 and 170, the credit card network respectively charges the customer's credit card account for the customer order and deposits payment in a bank account of a master merchant associated with the customer order and utilizing the system 100. Then, in step 172, the credit card network forwards a payment confirmation to the payment processor.

In step 174, the payment processor forwards the payment confirmation to the system 100. In step 176, upon receipt of the payment confirmation, the system 100 determines a payment (e.g., revenue share) for each of the master merchant and supplier utilizing the system 100 to fulfill the customer order and transmits the respective revenue share payments to the payment processor. Then, in step 178, the payment processor processes the revenue share payments via the credit card network. In steps 180 and 182, the credit card network respectively deposits the revenue share payments in the bank account of the master merchant and a bank account of the supplier. Then, in step 184, the credit card network forwards a revenue share payment confirmation to the payment processor. In step 186, the payment processor forwards the revenue share payment confirmation to the system 100. The system 100 confirms the revenue share payments and in step 188 fulfills the customer order. The process then returns to step 152.

As shown in FIG. 3, the system 100 provides several benefits for each of a distributor and a supplier. For example, a distributor can test new product and brands without incurring a cost, increase product offering and demand visibility, reduce inventory investment and risk, access a network of suppliers, realize higher net margin sales and access financed receivables (if necessary). Additionally, a supplier can increase inventory turnover and product demand visibility, realize higher margin sales, access a network of distributors, and realize cash flow resolution with immediate payment on dropship customer orders (e.g., no financed receivables).

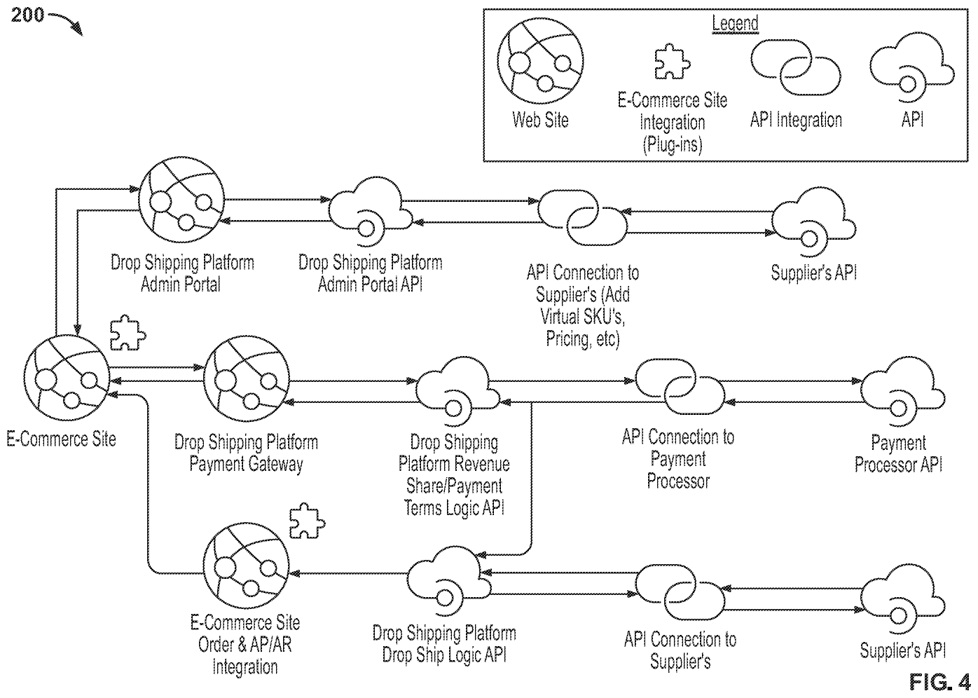

FIG. 4 is a flowchart illustrating an integration of the system 100 of the present disclosure within an electronic commerce system. As shown in FIG. 4, an e-commerce website and webpages thereof can integrate with the system 100 via one or more plug-ins. Additionally, a supplier and payment processor can integrate with the system 100 via respective integration API 106a connections. A drop shipping platform and payment gateway generated by the drop shipment module 106b can integrate with the system 100 via the drop shipment API 107.

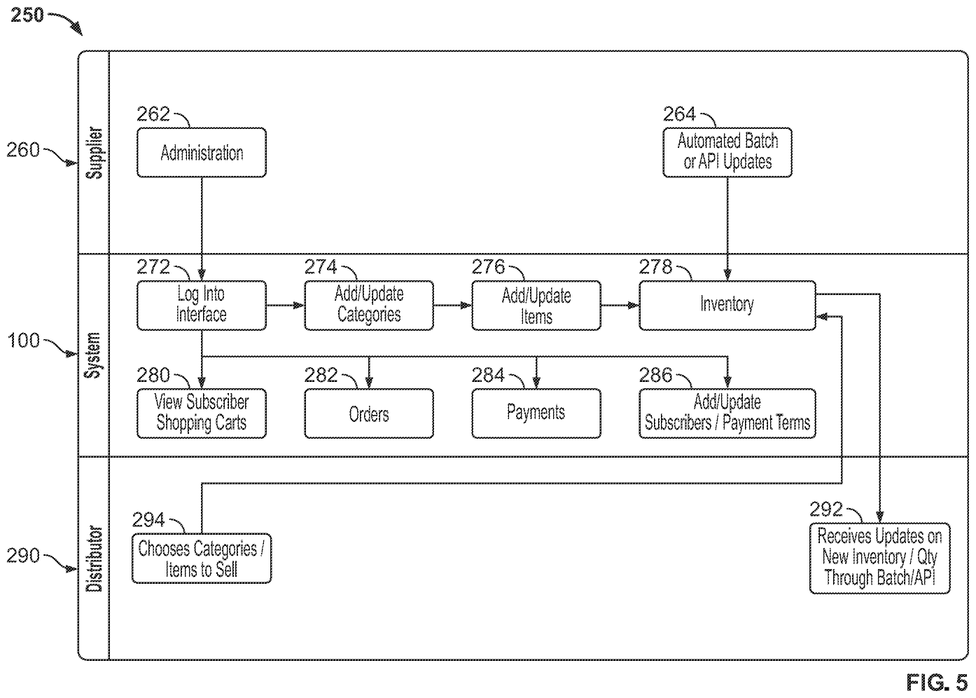

FIGS. 5-9 illustrate example processing carried out by the system 100 of the present disclosure between a supplier and a distributor integrated with the system 100. FIG. 5 is a flowchart 250 illustrating processing carried by the drop shipment module 106b of the system 100 with respect to a supplier 260 and a distributor 290. Beginning in step 262, a supplier navigates to a drop shipping platform administration portal website of the system 100. In step 272, the supplier logs into an interface of the system 100. From the system 100 interface, a supplier can select from a plurality of actions including adding and/or updating product categories in step 274, viewing distributor shopping carts in step 280, viewing orders in step 282, viewing payments in step 284 and adding and/or updating distributors and/or revenue share payment terms.

If a supplier adds and/or updates at least one product category in step 274, the process proceeds to step 276. In step 276, a supplier can add and/or update at least one product associated with a product category. Then, in step 278, a supplier can view an inventory of the at least one product. It should be understood that the drop shipment API 107 provides for communication between each of a supplier and a distributor via the integration API 106a. As such, in step 264, the drop shipment module 106b can receive automated batch or API updates with respect to inventory from a supplier. For example, the drop shipment module 106b can receive product identification information (e.g., a virtual stock keeping unit (SKU)), product pricing information, product quantity information, etc.) Additionally, in step 292, the drop shipment module 106b can transmit the received automated batch or API updates to a distributor. In step 294, a distributor can access the supplier inventory and select product categories and/or products to sell.

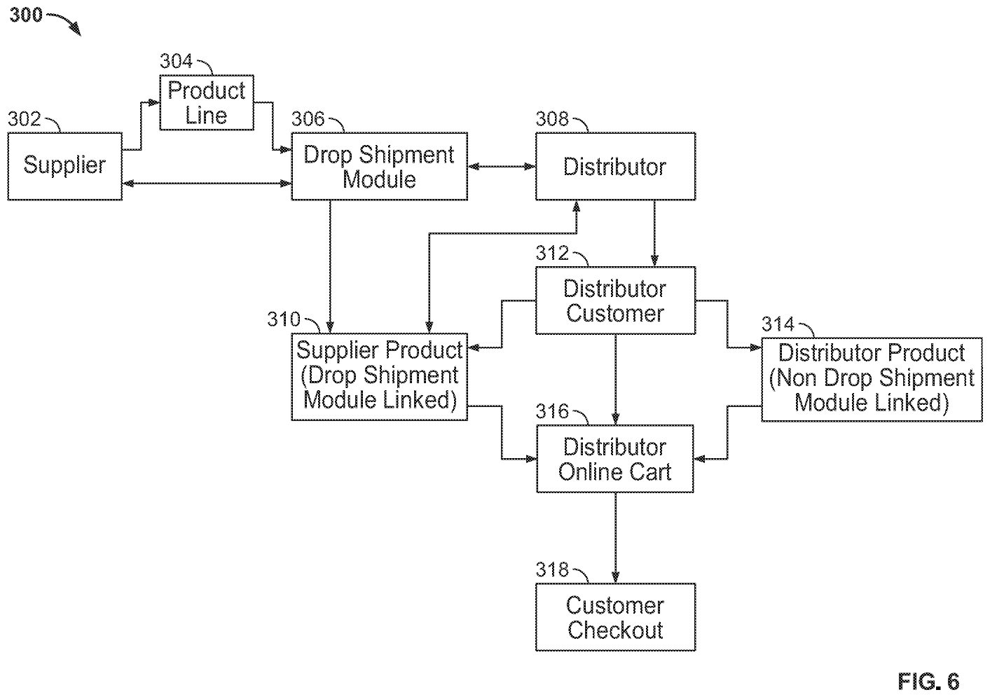

FIG. 6 is a flowchart 300 illustrating transaction processing carried out by the system 100 of the present disclosure. In step 302, a supplier is integrated with the system 100. It should be understood that a supplier can integrate with and utilize the system 100 via a plurality of subscription plans having a different monthly payment based on one or more of a volume of customer orders, an amount of SKUs and a level of integration and/or customization required by the supplier. It should also be understood that each subscription plan can include a different transaction fee representative of a per transaction commission based fee that includes a revenue share payment processing fee from the system 100 payment processing API integration.

In step 304, the supplier can add and/or update at least one product associated with a product category or product line. In step 306, the drop shipment module 106b generates a link for the added and/or updated at least one product thereby denoting that the product is associated with the supplier and exclusively available via the system 100. In step 308, a distributor is integrated with the system 100. In step 310, a distributor can view and integrate the linked supplier product into a website of the distributor. Then, in step 312, a distributor customer (e.g., an online shopper) can view the linked supplier product via the distributor website. It should be understood that the distributor customer can also view a non-linked distributor product in step 314. In step 316, the distributor customer can add each of the linked supplier product and non-linked distributor product to an online shopping cart. Then, in step 318, the distributor customer can checkout and pay for each of the linked supplier product and non-linked distributor product in the online shopping cart. At checkout, the payment transaction triggers the system 100 to split the payment for the linked supplier product in the online shopping cart and distribute the revenue share payment to the supplier after deducing the transaction fee. Each of the supplier and the distributor can track a current order, a product in a cart, process and view a return, view payment history and run a current report.

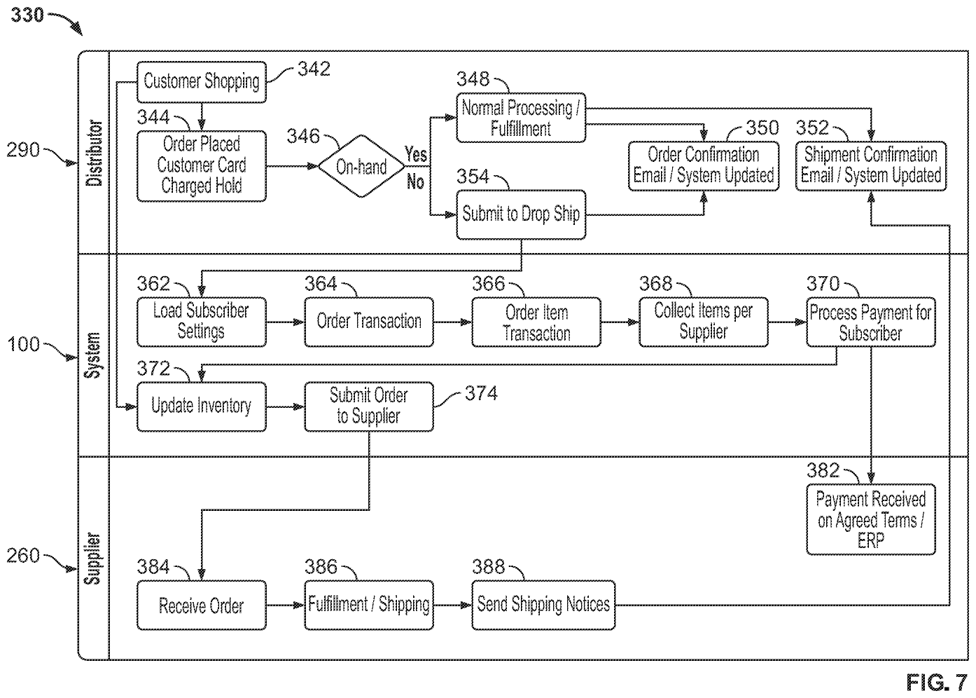

FIG. 7 is a flowchart 330 illustrating customer order flow carried out by the drop shipment module 106b of the system 100 with respect to a supplier 260 and a distributor 290. Beginning in step 342, a customer shops on a website of the distributor 290. In step 344, the customer places an order via the distributor website and the distributor 290 charges a credit card account of the customer. Then, in step 346, the distributor 290 determines whether a product associated with the customer order is on-hand. If the product associated with the customer order is on-hand, then in step 348, the distributor 290 proceeds with normal processing for order fulfillment. For example, in steps 350 and 352, the distributor 290 can respectively generate and transmit a customer order confirmation email and a customer order shipment confirmation email. Alternatively, if the product associated with the customer order is not on-hand, then the distributor 290 submits the customer order for drop shipment in step 354 and generates a customer order confirmation email in step 350.

In step 362, the system drop shipment module 106b loads at least one setting (e.g., revenue share payment terms) associated with the distributor 290. In steps 364 and 366, the system 100 respectively processes the customer order transaction and each product item associated with the customer order. In step 368, the system 100 collects product items per supplier 260 if multiple product items are associated with different suppliers. Then, in step 370, the system 100 processes revenue share payments for each of the supplier 260 and distributor 290. In step 372, the system 100 updates an inventory of each product item associated with the customer order, and in step 374 the system 100 submits the customer order to the supplier 260.

In step 382, the supplier 260 receives a revenue share payment for the processed customer order. It should be understood that when a supplier 260 receives a revenue share payment can depend on revenue share payment terms agreed to with a distributor 290. For example, a supplier may instantly receive a revenue share payment or receive the revenue share payment at a predetermined date. In step 384, the supplier 260 fulfills and ships the customer order. Then, in step 388, the supplier 260 transmits a shipment notice to the distributor 290 and the process returns to step 352. Upon receipt of the shipment notice from the supplier 260, the distributor 290 generates a customer order shipment confirmation email in step 352.

It should be understood that the system 100 can be scaled into a marketplace where a supplier may be another distributor. In particular, a supplier in the marketplace can approve a network of distributors to interact with one another in case the respective distributors have inventory exposure associated with a linked product that the original supplier no longer has. As such, the system 100 can identify a proximity of a linked product and fulfill a customer order for the linked product from the most proximate location to improve customer satisfaction.

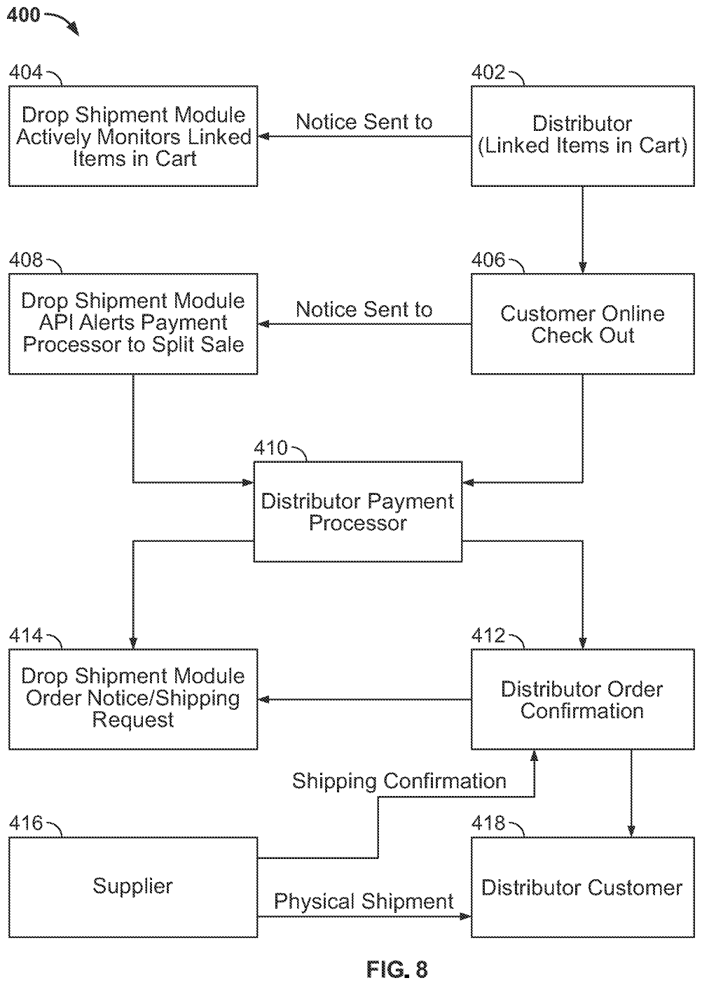

FIG. 8 is a flowchart 400 illustrating order processing carried out by the system 100 of the present disclosure. As mentioned above, the drop shipment module 106b generates a link for at least one supplier product thereby denoting that the product is associated with and exclusively available via the system 100. In step 402, a customer places a linked product in an online shopping cart associated with a distributor website. In step 404, the system 100 receives a notice from a distributor website indicating the presence of a linked product in the customer online shopping cart and monitors the linked product.

In step 406, the customer can checkout and pay for the linked product in the online shopping cart. In step 408, the drop shipment module 106b receives a notice from the distributor website indicating the occurrence of a payment transaction for the linked product in the online shopping cart and alerts a payment processor of the distributor to proceed with a revenue share payment for each of the distributor and supplier associated with the linked product. In step 410, the distributor payment processor processes payment for the linked product by charging the customer's credit card account for the linked product via a credit card network and processes the revenue share payment for each of the distributor and supplier associated with the linked product. In step 412, the distributor receives a payment confirmation from the distributor payment processor and generates and transmits an order confirmation based on the payment confirmation.

In step 414, the drop shipment module 106b receives the payment confirmation from the distributor payment processor and the order confirmation from the distributor and generates an order notice and shipping request for the linked product based on the received payment and order confirmations. In step 416, the supplier associated with the linked product generates and transmits a shipping confirmation for the linked product to the distributor and ships the linked product to the customer. In step 418, the customer receives the shipping confirmation generated by the supplier and forwarded by the distributor and the linked product from the supplier.

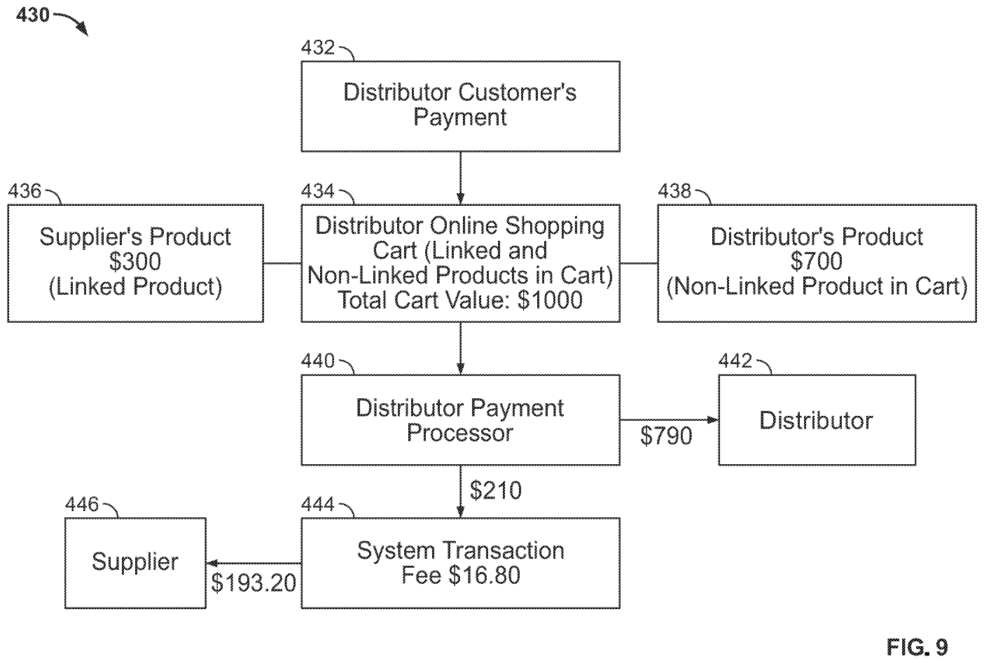

FIG. 9 is a flowchart 430 illustrating payment processing carried out by the system 100 of the present disclosure. In particular, FIG. 9 illustrates example payment processing carried out by the system 100 for a drop shipment module 106b linked product and an non-linked product at the occurrence of a payment transaction for the linked product and non-linked product in a customer online shopping cart. As mentioned above, the drop shipment module 106b generates a link for at least one supplier product thereby denoting that the product is associated with the supplier and exclusively available via the system 100.

In step 432, a customer enters a payment transaction for an order. In step 434 and at the occurrence of the customer payment transaction, a linked supplier product having a value of $300 (step 436) and a non-linked distributor product having a value of $700 (step 483) are present in the customer online shopping cart such that the total value of the customer payment is $1000. In step 440, a payment processor of the distributor processes a revenue share payment for each of the distributor and supplier associated with the linked product (based on a revenue share agreement between the distributor and supplier) and a conventional payment for the distributor associated with the non-linked product. In step 442, the distributor receives a total payment of $790 including a $90 revenue share payment for the linked product and a $700 payment for the non-linked product. In step 444, the system 100 deducts a transaction fee of $16.80 from the supplier's $210 revenue share payment for the linked product. In step 446, the supplier receives a $193.20 revenue share payment for the linked product after the deduction of the $16.80 transaction fee.

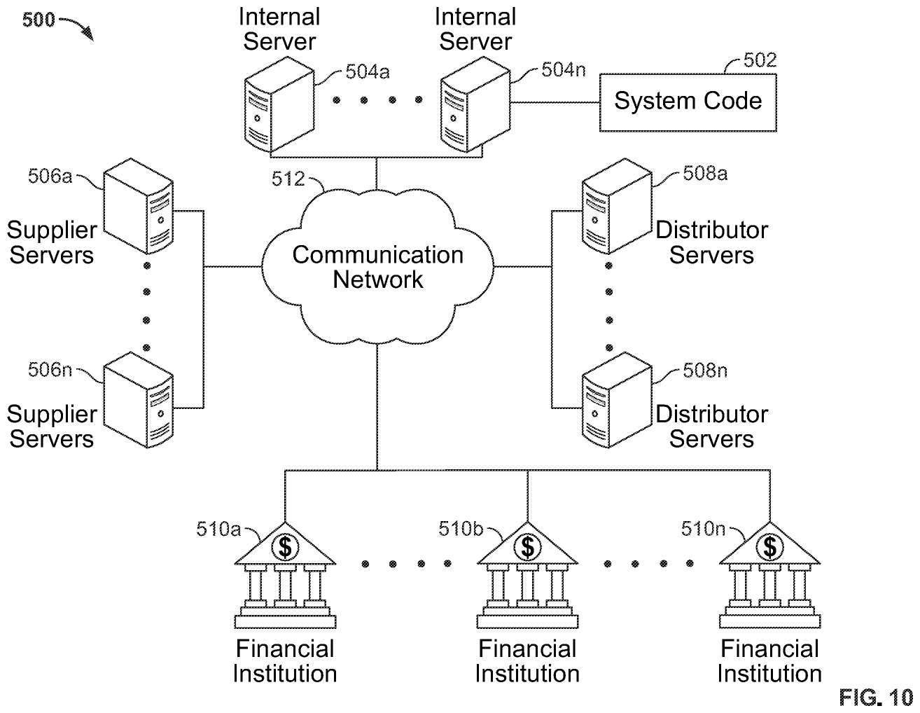

FIG. 10 is a diagram illustrating an embodiment of the system 500 of the present disclosure. In particular, FIG. 10 illustrates computer hardware and network components on which the system 500 could be implemented. The system 500 can include a plurality of internal servers 504a-504n having at least one processor and memory for executing the computer instructions and methods described above (which could be embodied as system code 502). The system 500 can also include a plurality of supplier servers 506a-506n and a plurality of distributor servers 508a-508n. The system 500 can also include a plurality of financial institutions 510a-510n for receiving and authorizing payments. The internal servers 504a-504n, the supplier servers 506a-506n, and the distributor servers 508a-508n can communicate via the system 500 APIs (not shown) over a communication network 512. Of course, the system 500 need not be implemented on multiple devices, and indeed, the system 500 could be implemented on a single computer system (e.g., a personal computer, server, mobile computer, smart phone, etc.) without departing from the spirit or scope of the present disclosure.

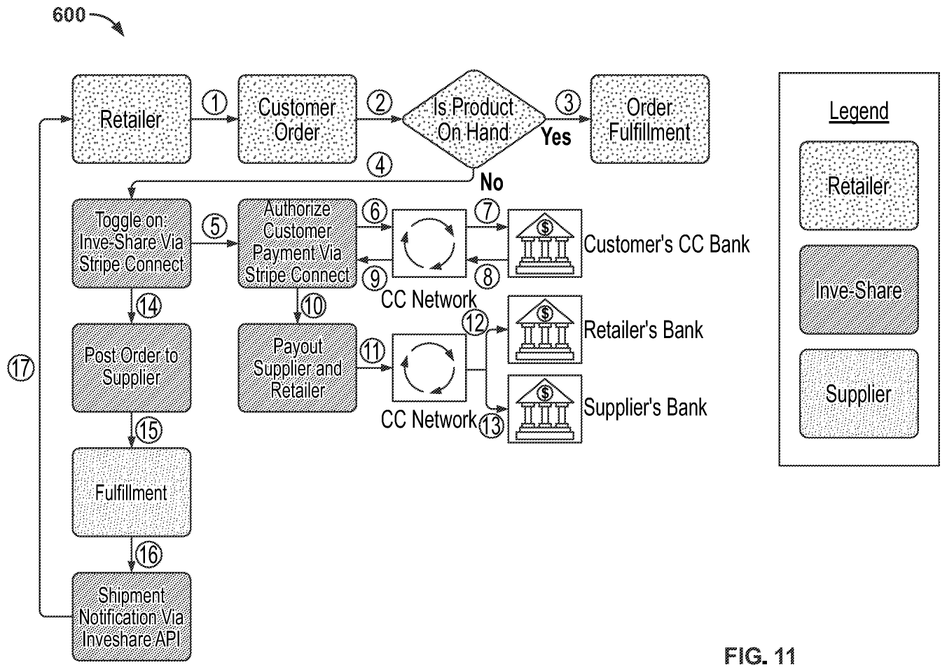

FIGS. 11-16C are flowcharts, diagrams, and screenshots illustrating another embodiment of the present disclosure. In this embodiment, the system generates a backend marketplace to list a product with a supplier using the supplier's current systems and software, without requiring the use of an additional software. The system allows distributors to shop for products from a supplier and seamlessly add them to their websites at the click of a button. Then, the distributors list the items on their website as they would any product. The system then receives orders from customers, at which point an order for a non-inventoried item made by a customer of the distributor will automatically be transmitted (with no additional clicks or other user actions required) into the existing system of the suppliers. At the time a customer checks out on the distributor's site, the system activates a payment processor that recognizes that there is a non-inventoried item. Once the payment processor is activated, a normal transaction for the customer of the distributor is continued, and the processor processes payment for the entirety of the order on behalf of the distributor. In capturing payment for the entire order, the system can attribute and split the payments (e.g., in accordance with pre-negotiated business terms between supplier and distributor) so that portions are paid to the supplier and distributor automatically (e.g., from a credit card or electronic transaction). The system can prompt a payment processor to distribute the determined revenue share payment associated with the linked product to the distributor and can update an inventory of the linked product. Additionally, the system can determine a transaction fee for determining the revenue share payment and prompt the payment processor to deduct the determined transaction fee from the determined revenue share payment associated with the linked product for the supplier and to distribute the modified revenue share payment associated with the linked product to the supplier. The supplier can then fulfill the order on behalf of the distributor, and in doing so, close out the order in their system and mark it as fulfilled, causing the system to automatically update the distributor with all relevant information for the fulfillment. It is noted that the system of the embodiment discussed in connection with FIGS. 11-16C is occasionally referred to herein and in the drawings as the “Inve-Share” system.

Turning to FIG. 11, a flowchart 600 illustrates overall processing steps carried out in this embodiment of the invention. In steps 1 and 2, a retailer receives a customer order. In step 3, the system determines whether a product is on hand. If so, the order is fulfilled. Otherwise, in step 5, the system is activated by a suitable payment processing platform, such as the “Stripe Connect” payment processing platform, or any suitable electronic payment processing platform. In step 6, the system authorizes the customer payment using the payment processing platform. In steps 7-9, a credit card electronic network processes the payment with the customer's credit card bank, and once processed, steps 10-13 occur, wherein the system electronically pays both the supplier and the retailer. In step 14, the system posts the processed order to the supplier. In step 15, the order is fulfilled by the supplier. In step 16, the system generates a shipment notification via an appropriate application programming interface (API) call, and in step 17, control of the system is returned to step 1.

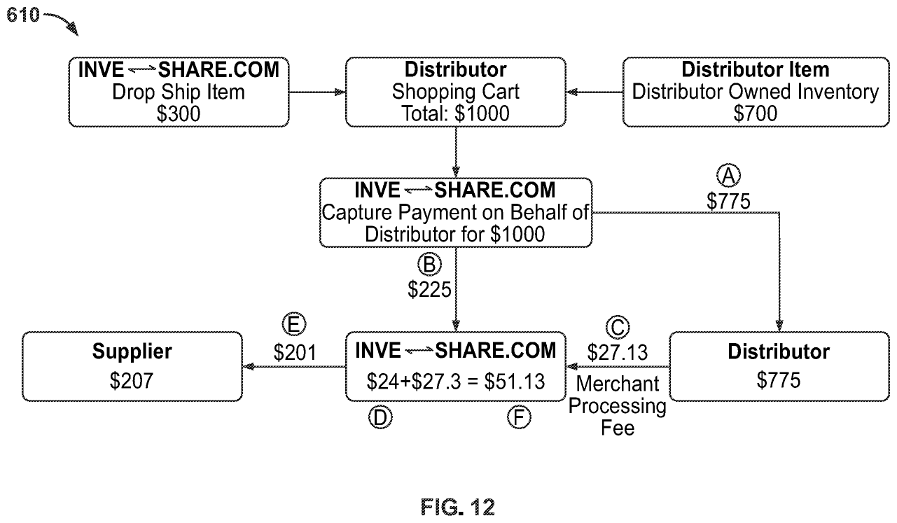

FIG. 12 is a diagram 610 illustrating a typical processing scenario carried out by the system. As can be seen, the system (in this case, a web-based version of the system referred to as the “Inve-Share.Com” system) receives a drop ship item (in the amount of $300), which is sent to the distributor's shopping card. Additionally, the distributor's item (from the distributor-owned inventory, in the amount of $700) is sent to the distributor shopping cart, resulting in a total of $1,000 attributable to the distributor's shopping cart. The system then captures a payment of $1,000 on behalf of the distributor. In step A, the system distributes a payment of $775 to the distributor, in step B, the system retains $225 (of the $1,000 payment). In step C, the distributor pays the system a merchant processing fee of $27.13. In step E, the supplier is paid $207 by the system, and in steps D and F, the system calculates a final retained payment of $51.13, which is retained by the system.

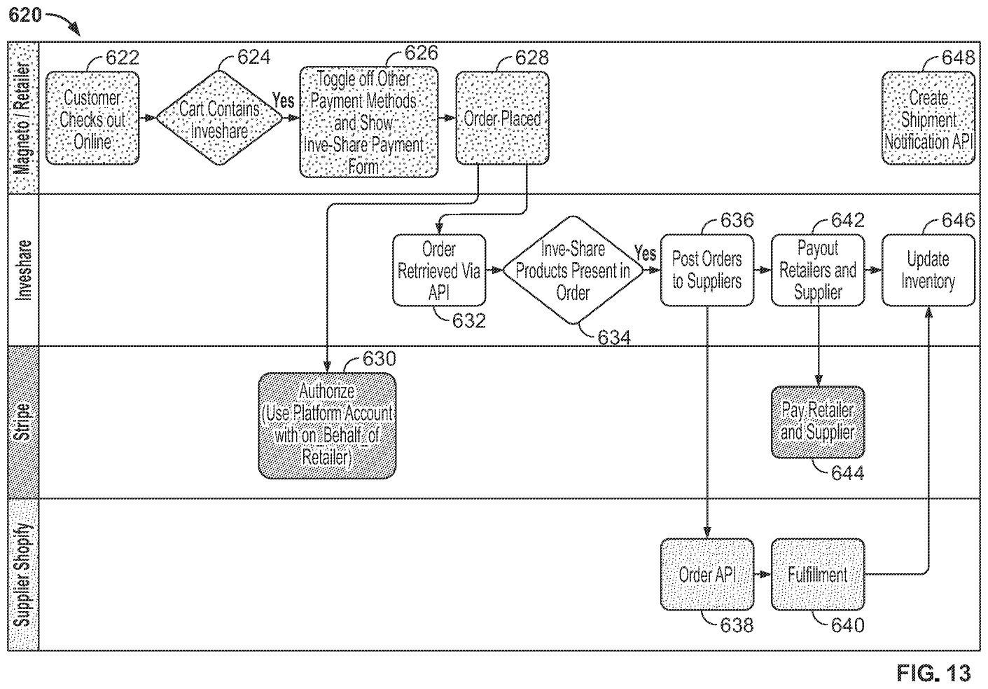

FIG. 13 is a flowchart 620 illustrating processing steps carried out by the system, in greater detail. In step 622, the customer checks out online. Then, in step 624, a determination is made as to whether the customer's cart is operable with the system of the present disclosure. If so, step 626 occurs, wherein the system deactivates (“toggles off”) other payment methods, and activates the payment methods of the present system, disclosed herein. In step 628, an order is placed. In step 630, an electronic payment processing platform (e.g., Stripe) authorizes payment on behalf of the retailer. In step 632, the order is retrieved by an appropriate API call. In step 634, a determination is made as to whether products compatible with the present disclosure are present in the order. If so, step 636 occurs, wherein the orders are posted to the suppliers. In step 638, the supplier (using a suitable electronic platform, such as Shopify) accesses the order via a suitable API. Then, in step 640, the order is fulfilled by the supplier, and in step 646, the inventory is updated. Additionally, in step 642, the system pays out retailers and the supplier, and in step 644, the electronic payment platform (e.g., Stripe) electronically conducts the payments. Finally, in step 648, the system creates a shipment notification via a suitable API call.

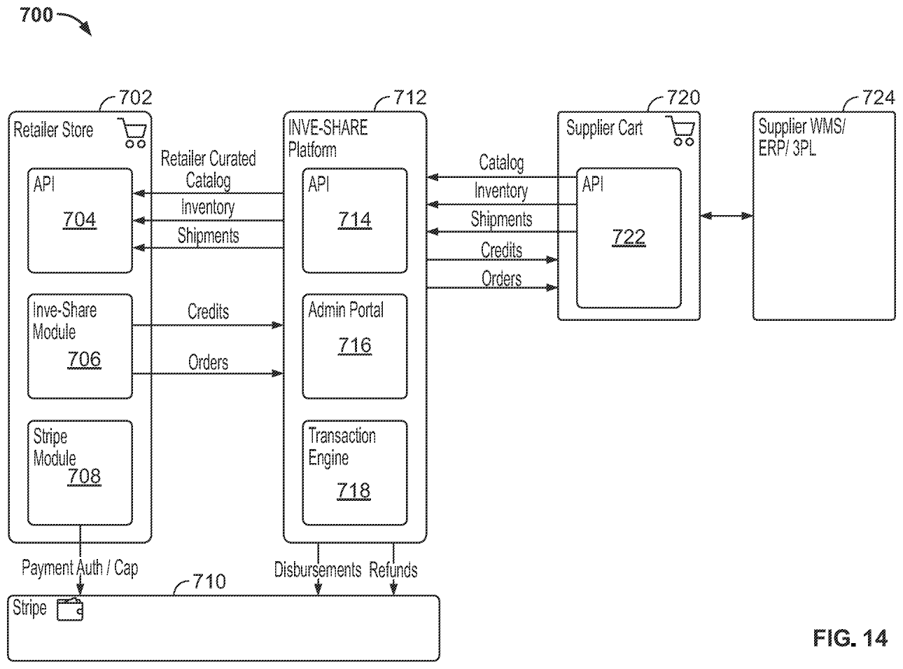

FIG. 14 is a diagram 700 illustrating hardware and software components of the embodiments of the present disclosure discussed herein in connection with FIGS. 11-16C. A retail store computer system 702 stores and executes an API 704 (for accessing the system of the present disclosure, which is indicated in FIG. 14 as platform 712), a local system module 706, and a third-party electronic payment access module 708 (which communicates with a third-party payment platform 710, such as Stripe). The platform 712 also stores and executes an API 714 for communicating with both the retail store computer 702 and a supplier electronic shopping cart 720, an administrative portal module 716, and a transaction engine 718 (which communicates with the payment platform 710). The supplier shopping cart 720 includes an API 722 for communicating with the platform 712, and also communicates with a supplier back-end processing computer system 724. As can be seen in FIG. 14, using the various APIs, the retail store computer 702 communicates orders and credits to the platform computer 712 and receives retailer-curated catalogs, inventory, and shipment data from the platform computer 712, and also communicates payment authorizations electronically to the payment platform 710. Additionally, the platform 712 communicates credits and orders with the supplier electronic cart 720, and receives catalogs, inventory, and shipment data from the cart 720, again using appropriate APIs.

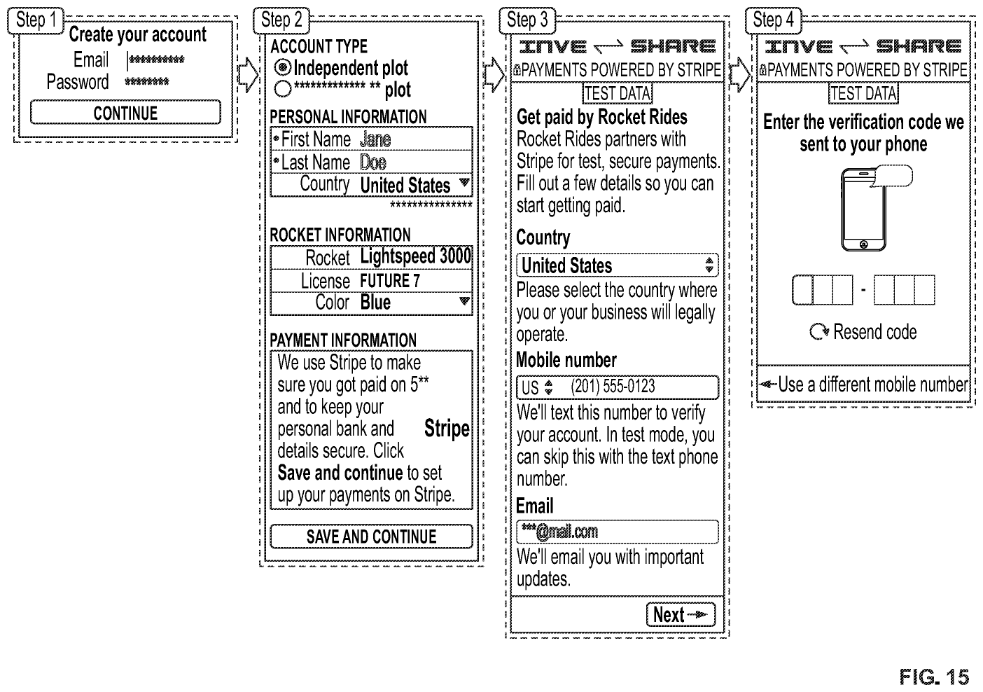

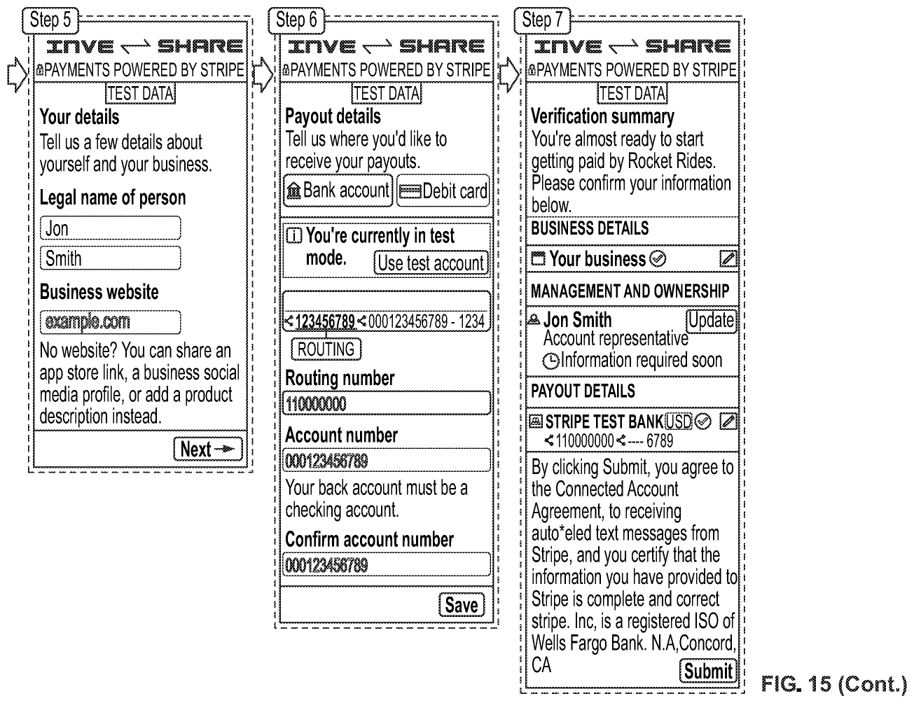

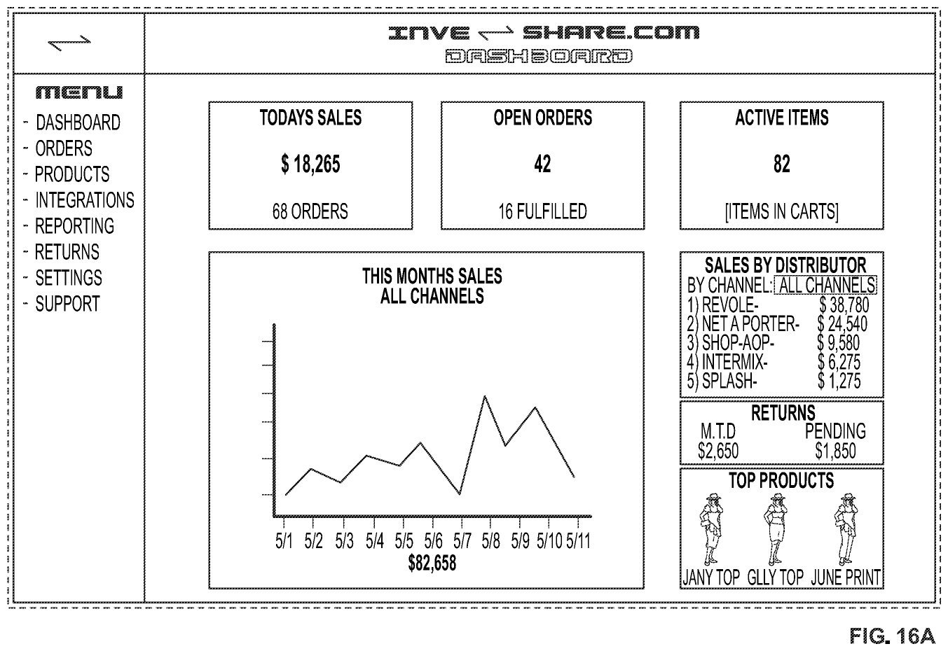

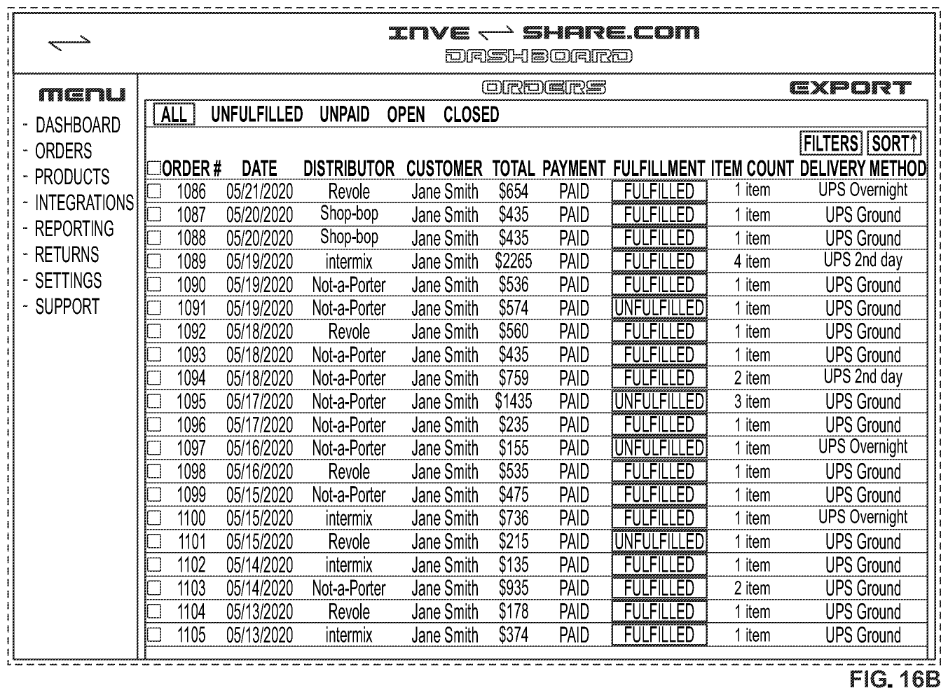

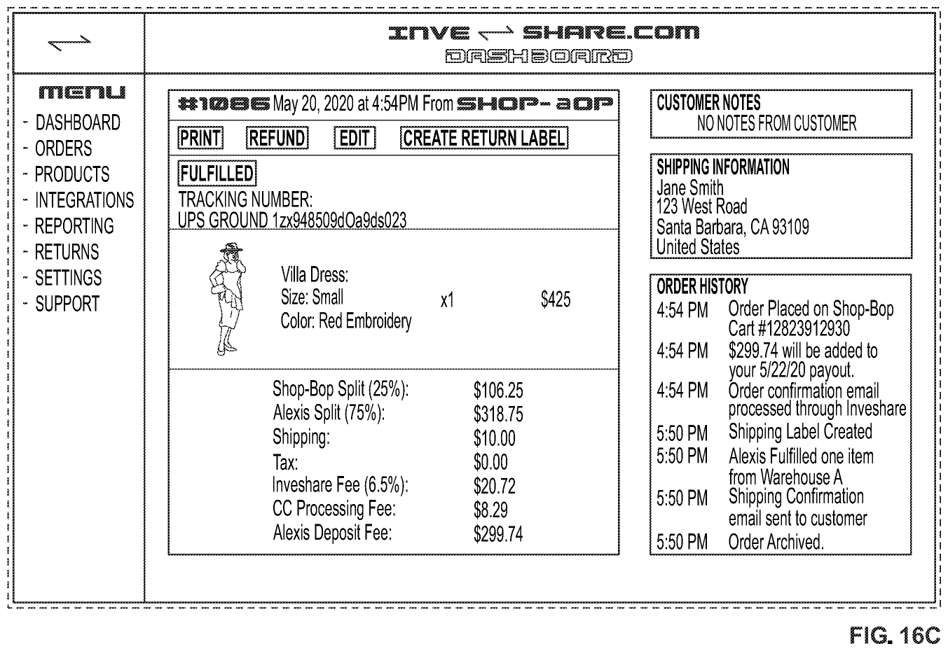

FIGS. 15-16C are screenshots illustrating various user interface screens generated by the system. As shown in FIG. 15, in steps 1-2, the user can create an account using the screens shown therein, and in steps 3-5, the user can enroll in electronic payments. In steps 6-7, the system allows the user to provide payout details (e.g., accounts to which payments will be electronically transmitted) as well as verification information. As shown in FIGS. 16A-16C, once the user is enrolled in the system, an electronic dashboard is provided, allowing the user to have real-time access to orders, products, integrations, reports, returns, settings, and support. As can be seen, comprehensive summaries of sales, orders, and active items are provided, as well as detailed fulfilment information.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed:

1. A system for electronic payment and order processing for a drop shipment system comprising:
a memory; and
a processor in communication with the memory, the processor:
generating a link to associate a product with a supplier and the system,
receiving an order confirmation from a distributor for the linked product, the linked product being offered for sale on a website of the distributor;
transmitting a drop ship order fulfillment request to the supplier for the linked product; and
determining a revenue share payment associated with the linked product for each of the distributor and the supplier based on a revenue share payment agreement.

2. The system of claim 1, wherein the processor
receives a notification when the linked product is present in a customer shopping cart associated with the distributor.

3. The system of claim 1, wherein the processor
receives a notification upon a payment transaction for the linked product,
prompts a payment processor to distribute the determined revenue share payment associated with the linked product to the distributor, and
updates an inventory of the linked product.

4. The system of claim 3, wherein the processor
determines a transaction fee for determining the revenue share payment,
prompts the payment processor to deduct the determined transaction fee from the determined revenue share payment associated with the linked product for the supplier, and
prompts the payment processor to distribute the modified revenue share payment associated with the linked product to the supplier.

5. The system of claim 3, wherein the processor
determines a transaction fee for determining the revenue share payment,
prompts the payment processor to deduct the determined transaction fee from the determined revenue share payment associated with the linked product for the supplier, and
prompts the payment processor to distribute the modified revenue share payment associated with the linked product to the supplier on a predetermined date.

6. The system of claim 1, wherein the distributor and the supplier integrate and communicate with the system via an application programming interface.

7. A method for electronic payment and order processing for a drop shipment system, comprising the steps of:
generating a link to associate a product with a supplier and the system,
receiving an order confirmation from a distributor for the linked product, the linked product being offered for sale on a website of the distributor;
transmitting a drop ship order fulfillment request to the supplier for the linked product; and
determining a revenue share payment associated with the linked product for each of the distributor and the supplier based on a revenue share payment agreement.

8. The method of claim 7, further comprising:
receiving a notification when the linked product is present in a customer shopping cart associated with the distributor.

9. The method of claim 7, further comprising:
receiving a notification upon a payment transaction for the linked product,
prompting a payment processor to distribute the determined revenue share payment associated with the linked product to the distributor, and
updating an inventory of the linked product.

10. The method of claim 9, further comprising:
determining a transaction fee for determining the revenue share payment,
prompting the payment processor to deduct the determined transaction fee from the determined revenue share payment associated with the linked product for the supplier, and
prompting the payment processor to distribute the modified revenue share payment associated with the linked product to the supplier.

11. The method of claim 9, further comprising:
determining a transaction fee for determining the revenue share payment,
prompting the payment processor to deduct the determined transaction fee from the determined revenue share payment associated with the linked product for the supplier, and
prompting the payment processor to distribute the modified revenue share payment associated with the linked product to the supplier on a predetermined date.

12. The method of claim 7, wherein the distributor and the supplier integrate and communicate with the system via an application programming interface.

13. A non-transitory computer readable medium having instructions stored thereon for electronic payment and order processing for a drop shipment system which, when executed by a processor, causes the processor to carry out the steps of:
generating a link to associate a product with a supplier and the system,
receiving an order confirmation from a distributor for the linked product, the linked product being offered for sale on a website of the distributor;
transmitting a drop ship order fulfillment request to the supplier for the linked product; and
determining a revenue share payment associated with the linked product for each of the distributor and the supplier based on a revenue share payment agreement.

14. The non-transitory computer readable medium of claim 13, the processor further carrying out the step of receiving a notification when the linked product is present in a customer shopping cart associated with the distributor.

15. The non-transitory computer readable medium of claim 13, the processor further carrying out the steps of:
receiving a notification upon a payment transaction for the linked product,
prompting a payment processor to distribute the determined revenue share payment associated with the linked product to the distributor, and
updating an inventory of the linked product.

16. The non-transitory computer readable medium of claim 15, the processor further carrying out the steps of:
determining a transaction fee for determining the revenue share payment,
prompting the payment processor to deduct the determined transaction fee from the determined revenue share payment associated with the linked product for the supplier, and
prompting the payment processor to distribute the modified revenue share payment associated with the linked product to the supplier.

17. The non-transitory computer readable medium of claim 15, the processor further carrying out the steps of:
determining a transaction fee for determining the revenue share payment,
prompting the payment processor to deduct the determined transaction fee from the determined revenue share payment associated with the linked product for the supplier, and
prompting the payment processor to distribute the modified revenue share payment associated with the linked product to the supplier on a predetermined date.

18. The non-transitory computer readable medium of claim 13, wherein the distributor and the supplier integrate and communicate with the system via an application programming interface.
